(19) United States
(12) Patent Application Publication
(10) Pub. No.: US 2004/0262056 A1
(43) Pub. Date: Dec. 30, 2004

(54) Electric scooter

(76) Inventor: Xiongxin Ying, Yong Kang City (CN)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/769,789

(22) Filed: Feb. 3, 2004

(30) Foreign Application Priority Data
Jun. 27, 2003 (CN) 03232682.3

(51) Int. Cl. B60K 1/00

(52) U.S. Cl. 180/65.1

(57) ABSTRACT

The present utility discloses a kind of electric scooter comprises scooter body, front and rear steering linkage mechanisms provided on the scooter body, two right and left front wheels and two right and left rear wheels provided respectively on the front and rear steering linkage mechanisms. Said scooter body is provided with a controller and storage battery, said rear steering linkage mechanism is provided with an electrically driving device. Said steering linkage mechanism comprises a hinge seat, right and left rocker arms, right and ball head pitmen, right and left ball head screws and right and left internal ball head screws, the hinge seat is hinged to the scooter body, the right and rocker arms are provided fixedly on both sides of the hinge seat. The right and left internal ball head screws are fixed to both sides of the scooter body below hinge seat, the right and left ball head screws are fixed respectively to the mid-arms of the right and left rocker arms, the two ends of the left ball head pitman are respectively hinged to the left ball head screw and the left internal ball head screw, in same manner, the two ends of the right ball head pitman are respectively hinged to right ball head screw and the right internal ball head screw. The scooter according to present invention has such advantages as simple construction, easy to learn, convenient control over the electrically driving operation, good function of equilibrium, low risk of danger and suitable to glide on smooth road surface, etc.

### TECHNICAL FIELD

The present utility relates to a scooter, in particular, to an electric scooter with four wheels.

### BACKGROUND ART

It is known that the scooter is a kind of sports apparatus for amusement and gymnastics. In developed countries, it is very popular to young people, and in coastal cities of China, some young people has already experienced this kind of sport. The scooter requires good playing skills and ground. While playing, it is necessary not only to have good balance ability and coordinate ability for turning direction, but also to provide forward power to glide the scooter by incessantly stepping on the ground with one foot. However, being difficult to control the balance and coordination, accident of falling over or turning over is liable to take place, thereby to cause serious injuries to the player. This imposes a restriction on the development of scooter playing sport. Owing to the factor of physical strength, even experienced players cannot play it for a long time or a long distance. Moreover, the steering linkage mechanism of the prior art scooters is not rational, some of them are provided even with universal wheels to control the direction, which cause troubles to the beginners to smoothly drive the scooter.

### III. SUMMARY OF THE INVENTION

The object of the present utility is to provide a kind of scooter which is driven by motor and the steering is controlled by the offset of the center of gravity of player, so as to overcome the defects of irrationality of the steering linkage mechanism and no power provided in the prior art scooter.

The technical solution adopted by the present utility is that the scooter comprises scooter body, front and rear steering linkage mechanisms provided on the scooter body, two right and left front wheels and two right and left rear wheels provided respectively on the front and rear steering linkage mechanisms. Said scooter body is provided with a controller and storage battery, said rear steering linkage mechanism is provided with an electrically driving device. Said steering linkage mechanism comprises a hinge seat, right and left rocker arms, right and ball head pitmen, right and left ball head screws and right and left internal ball head screws, the hinge seat is hinged to the scooter body, the right and rocker arms are provided fixedly on both sides of the hinge seat. The right and left internal ball head screws are fixed to both sides of the scooter body below hinge seat, the right and left ball head screws are fixed respectively to the mid-arms of the right and left rocker arms, the two ends of the left ball head pitman are respectively hinged to the left ball head screw and the left internal ball head screw, in same manner, the two ends of the right ball head pitman are respectively hinged to right ball head screw and the right internal ball head screw.

Said electrically driving device comprises a motor seat fixed on the left rocker arm of the rear steering linkage mechanism, a motor fixed on the motor seat, a driving wheel fixed on the output shaft of the motor and a driven wheel fixed on the left rear wheel, the driving and driven wheels are linked by a synchro belt.

A footboard is fixed on said scooter body, on which a speed switch controlled by foot is provided.

In present utility, when speed switch is pressed and turned on, the controller comes into operation, the motor starts up to drive left rear wheel through the transmission mechanism, and drive other wheels to rotate along with it simultaneously. While turning directions, the center of gravity of the player's body is to incline towards the revolving center, the two hinge seats on the front and rear steering linkage mechanisms fixed to the right and left rocker arms rotate relative to the scooter body, consequently, the right and left ball head screws and the right and left ball head pitmen are driven to deflect by the right and left rocker arms, the scooter body is impelled to incline towards the revolving center, so as to achieve a easy left or right turn. Being an ideal amusing and gymnastical sports apparatus for the young people, this kind of scooter has such advantages as simple construction, easy to learn, convenient control by the electrically driving operation, good equilibrium, low risk of danger and suitable to glide on smooth road surface, etc.

### IV. Brief Description of the Accompanying Drawings

FIG. 1 is a schematic structural diagram of the present utility.

FIG. 2 is a top view of FIG. 1.

FIG. 3 is a sectional view of FIG. 1 along line A-A.

FIG. 4 is a sectional view of FIG. 1 along line A-B.

FIG. 5 is a schematic structural diagram of the electrically driving device.

### V. Detailed Description of Preferred Embodiments

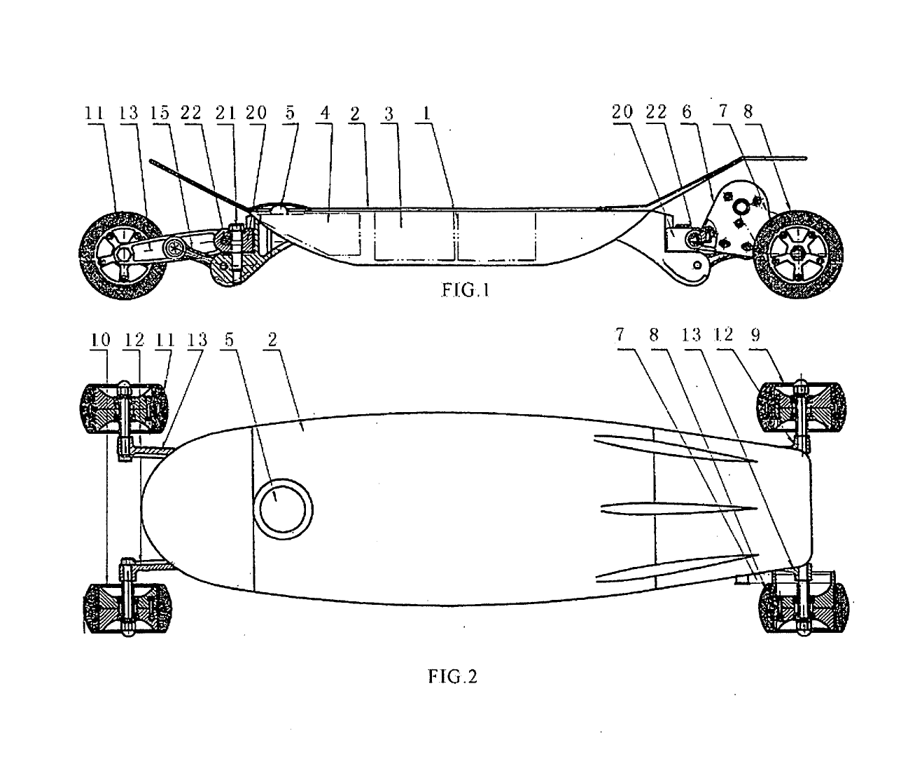

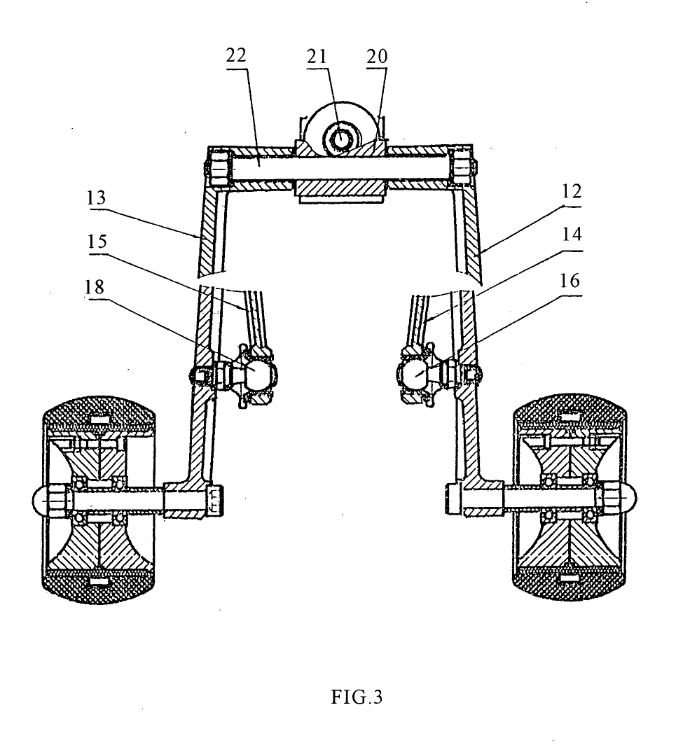

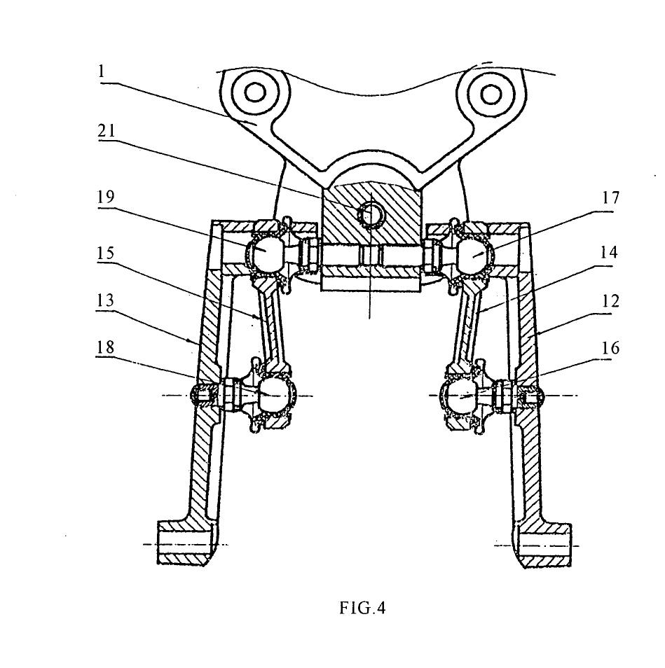

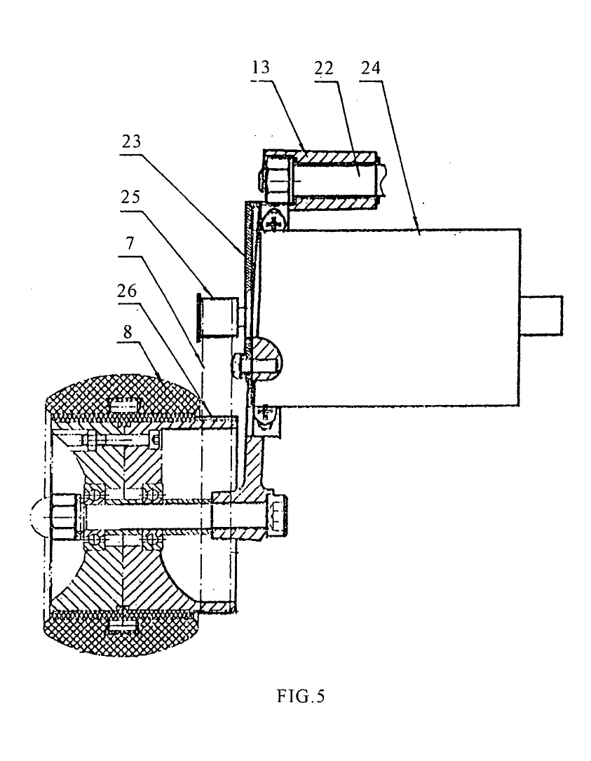

As shown in FIGS. 1 to 5, the present utility comprises the scooter body 1, the front and rear steering linkage mechanism provided on the scooter body 1, two front wheels 10, 11 and two rear wheels 8, 9 provided respectively on front and rear steering linkage mechanism. Said scooter body 1 is provided with a controller 4, a storage battery 3, a footboard 2 on which a speed switch 5 controlled by foot is provided and an electrically driving device installed on the rear steering linkage mechanism. Said steering linkage mechanism comprises a hinge seat 20, right and left rocker arms 12, 13, right and left ball head pitmen 14, 15, right and left ball head screws 16, 18 and right and left internal ball head screws 17, 19, the hinge seat 20 is hinged to the scooter body 1, the right and left rocker arms 12, 13 are fixed on corresponding sides of the hinge seat 20. The right and left internal ball head screws 17, 19 are fixed to both sides of the scooter body 1 below the hinge seat 20, the right and left ball head screws 16, 18 is fixed respectively to the mid-arms of the right and left rocker arms 12, 13, the two ends of left ball head pitman 15 are respectively hinged to the left ball head screw 18 and the left internal ball head screw 19, and the two ends of the right ball head pitman 14 are respectively hinged to the right ball head screw 16 and the right internal ball head screw 17. Said electrically driving device comprises a motor seat 23, a motor 14, a driving wheel 25 and a driven wheel 26 fixed on the left rear wheel 8, the motor seat 23 is fixed on the left rocker arm 13 of the rear steering linkage mechanism, the motor 24 is fixed on the motor seat 23, the driving wheel 24 is fixed on the output of the motor, and the driving wheel 25 and driven wheels 26 are linked by a synchro belt 7. While playing the scooter, the player stands on the footboard 2, one foot steps on speed switch 5 to turn it on. Subsequently, the controller 4 starts to work and the motor 24 rotates. The motor 24 drives the left rear wheel 8 to rotate through the driving wheel 25, synchro belt 7 and the driven wheel 26, and drives other wheels to rotate along with it simultaneously. The speed is controlled by the controller 4, of course, it can also be controlled by way of remote device. While turning direction, the center of gravity of the player is to incline towards the revolving center, the two hinge seats 20 located respectively on the front and rear steering linkage mechanisms and fixed to the right and left rocker arms 13, 12 rotate relative to the scooter body 1, and the right and left rocker arms 13, 12 drive the right and left ball head screws 18, 16 and the right and left ball head pitmen 15, 14 to make a deflection, and impel the scooter body 1 to incline towards the revolving center, so as to achieve an automatic turn to left or right.

Of course, the electrically driving device can as well be mounted on the right rocker arm 12 of the rear steering and linkage mechanism, the object of this invention can be achieved similarly. Specifically, the driven wheel 26 of said electrically driving device is fixed on the right rear wheel 9, the motor seat 23 is fixed on the right rocker arm 12 of the rear steering linkage mechanism, the motor 24 is fixed on the motor seat 23, the driving wheel 25 is fixed on the output shaft of the motor, and the driving wheel 25 and driven wheels 26 are linked by a synchro belt 7.

1. An electric scooter comprising a scooter body (1), front and rear steering linkage mechanisms provided on the scooter body (1) as well as two front wheels (10, 11) and two rear wheels (8, 9) provided respectively on the front and rear steering linkage mechanisms,
characterized in that said scooter body (1) is provided with a controller (4) and a storage battery (3), the rear steering linkage mechanism is provided with an electrically driving device;
said steering linkage mechanism comprises a hinge seat (20), right and left rocker arms (13,12), right and left ball head pitmen (15,14), right and left ball head screws (18, 16) and right and left internal ball head screws (19,17), the hinge seat (20) is hinged to the scooter body (1), the right and left rocker arms (13,12) are fixed on both sides of the hinge seat (20), the right and left internal ball head screws (19, 17) are fixed to both sides of the scooter body (1) below the hinge seat (20), the right and left ball head screws (18, 16) are fixed respectively to the mid-arms of the right and left rocker arms (13, 12), the two ends of the left ball head pitman (15) are respectively hinged to the left ball head screw (18) and the left internal ball head screw (19), and the two ends of the right ball head pitman (14) are hinged to the right ball head screw (16) and the right internal ball head screw (17).

2. The electric scooter according to claim 1, wherein said electrically driving device comprises a motor seat (23), a motor (24), a driving wheel (25) and a driven wheel (26) fixed on the left rear wheel (8), the motor seat (23) is fixed on the left rocker arm (8) of the rear steering linkage mechanism, the motor (24) is fixed on the motor seat (23), the driving wheel (25) is fixed on the output shaft of the motor, and the driving and driven wheel (25), (26) are linked by a synchro belt (7).

3. The electric scooter according to claim 1, wherein a footboard (2), on which a speed switch controlled by foot is provided, is fixed on said scooter body (1).
